(19) United States
(12) Patent Application Publication
(10) Pub. No.: US 2017/0001592 A1
(43) Pub. Date: Jan. 5, 2017

(54) Airbag Covering and Method for Producing Same

(71) Applicant: AUTOLIV DEVELOPMENT AB, Vargarda (SE)

(72) Inventors: Bernhard Jahme, Stadthergen (DE); Michael Weissenböck, München (DE); Heinrich Mayer, Friedberg (DE)

(21) Appl. No.: 15/100,094

(22) PCT Filed: Nov. 27, 2014
(86) PCT No.: PCT/EP2014/075789

§ 371 Date: May 27, 2016

(30) Foreign Application Priority Data
Nov. 28, 2013 (DE) 10 2013 019 940.9

(51) Int. Cl. B60R 21/215; B60R 21/205

(52) U.S. Cl. CPC B60R 21/215; B60R 21/205; B60R 2021/21543; B60R 2021/21531

(57) ABSTRACT

An airbag covering with a covering element (20) with an upper side and a lower side and at least two axially extending openings (22) from an upper end to a lower end, and with an emblem or design element on the covering element (20). The design element has at least two fastening pins (34) extending in the axial direction from the emblem section (32) through one opening (22). The fastening pin (34) has a thickened head (36) produced by thermal deformation. At least sections of the contact surface (38) of the head (36), which contact surface (38) faces the lower side of the covering element, do not extend perpendicularly to the axial direction.

### CROSS REFERENCE TO RELATED APPLICATIONS

This application claims priority to German Patent Application No. 10 2013 019 940.9, filed on Nov. 28, 2013 and PCT/EP2014/075789, filed on Nov. 27, 2014.

### FIELD OF THE INVENTION

The invention relates to an airbag cover for a motor vehicle as well as a method for its manufacture.

### BACKGROUND

It is known, particularly in the case of front driver-side airbag modules that are disposed in the hub region of the steering wheel, to provide an emblem on the airbag cover, which airbag cover in the normal state delineates the airbag in relation to the interior of the motor vehicle, in particular an emblem in the form of a company logo of the motor vehicle manufacturer or a design, for example, in the form of a wreath. The emblem or the design is here often a part of a separate emblem or design element that is disposed on a cover element. As this emblem or design is, as a rule, intended to be disposed centrally on the steering wheel hub, the region of the cover element on which the emblem or the design is disposed often serves as the outlet door for the airbag. In consequence, high acceleration forces act on the region of the airbag cover on which the emblem or design is located when the airbag is deployed. The emblem or design element must accordingly be firmly attached to the cover element in order to securely preclude a detachment in the event of an accident. Because the outlet door should of course open as quickly as possible, there is also the additional requirement that the emblem or design element have a mass as low as possible to be accelerated.

In order to be able to meet both requirements equally well, an airbag cover of the above-described type is proposed in DE 10 2008 005 419 B3 including an emblem or design element that is constructed as follows: the airbag cover has an at least two-part cover elements. This cover element is formed of a base body made of a relatively soft material and a reinforcement element held on this base body. The base body has a contact layer with a first surface and a tubular protrusion extending away from the contact layer. The reinforcement element with at least one recess in which the tubular protrusion is located is arranged below the contact layer. Arranged on the cover element is an emblem or design element with a visible emblem or design section arranged on the first surface, and at least one fastening pin that extends from the emblem or design section through the tubular protrusion. The end of the fastening pin that faces away from the emblem or design section abuts solely on the elastic tubular protuberance and is configured as a thickened head whose diameter is greater than the inner diameter of the tubular protuberance. In this way, the emblem or design element only comes into contact with the elastic cover element, which due to its elastic deformability, absorbs the acceleration forces that arise, whereby force peaks that could lead to a break in the fastening pin are reduced. For this reason, the fastening pins can be quite thin, and thus formed with low mass.

The manufacture of this airbag cover takes place as follows: first, the reinforcement element is arranged on the base body and for example glued, and then the emblem or design element is arranged on the cover element such that the emblem or design section rests on the first surface of the contact layer, and the fasting pins of the emblem or design element extend respectively through a tubular protrusion of the cover element. In a subsequent process step, the ends of the fastening pins are thermally reshaped so as to form the thickened head.

Even if the airbag cover described there completely resolves the problem posed, the relatively high manufacturing cost is disadvantageous, particularly as it is absolutely necessary to form the cover element as having at least two parts, with a relatively soft base body.

On this basis, one object of the present invention is the further development of an airbag cover of the above-described type such that it can be manufactured more economically while retaining its favorable properties with regard to the mass to be accelerated and operational safety.

This object is achieved by an airbag cover having the features described herein including a description of a method of manufacturing an airbag cover of this kind.

The basic construction of the airbag and the method of manufacturing it are similar in overall respects those known in the prior art as described above; namely, the cover consists of a cover element that has an upper side and a lower side, the cover element having at least two openings that extend from an upper to a lower end, and an emblem or design element arranged on the cover element, the emblem or design element having a visible emblem or design section on the upper side of the cover element, and at least two fasting pins that extend respectively from the emblem or design section through an opening, wherein each fastening pin has a thickened head obtained by thermal shaping.

According to the invention the necessary absorption of force peaks during the opening of the cover is not achieved solely by the relatively soft material properties of the part of the cover element against which the head of the emblem or design element abuts, but rather further due to the form of the head of the emblem or design element, i.e. as a result of the contact surface of the head pointing toward the underside of the cover element not extending vertically, at least in sections, in the axial direction, the contact surface preferably being formed as non-flat, in particular as conical or convex. Due to this shaping, there can be a plasti deformation of the cover element, which reduces the force peaks that arise with the expansion of the airbag, even if the cover element consists of a relatively hard plastic, which can in turn render the use of a reinforcing element superfluous. However it is also fundamentally possible to use an inventively formed head in combination with a relatively soft cover element, which would make possible a further reduction in the mass.

In a preferred embodiment according to this invention, the head is, at least in sections, accommodated in the lower end of the opening (to some extent like a countersunk screw). This reduces in particular the risk of the airbag that is covered by the airbag cover being damaged by the head.

A form of the head that has proven particularly suitable is described herein.

Further preferred embodiments are seen in the following exemplary embodiment described in more detail below with reference to the figures.

It should also be mentioned that an inventive airbag cover will as a rule have at least two fastening pins, the head of both fastening pins being formed.

### BRIEF DESCRIPTION OF DRAWINGS

The invention will now be explained in more detail with reference to the Figures.

FIG. 1 shows a highly schematized cross-section through an airbag module,

FIG. 2 shows the detail D in FIG. 1,

FIG. 3 shows the example shown in FIG. 2 during the fitting of the emblem or design element to the cover element

FIG. 4 shows a variation of the example shown in FIG. 2,

FIG. 5 shows a second exemplary embodiment of the invention in a representation corresponding to FIG. 2,

FIG. 6 shows a variation of the example shown in FIG. 5,

FIG. 7 shows a further variation of the form of a thickened head in a representation corresponding to FIG. 2, and

FIG. 7a shows a section through the pin in FIG. 7 along the plane A-A of FIG. 7.

### DETAILED DESCRIPTION

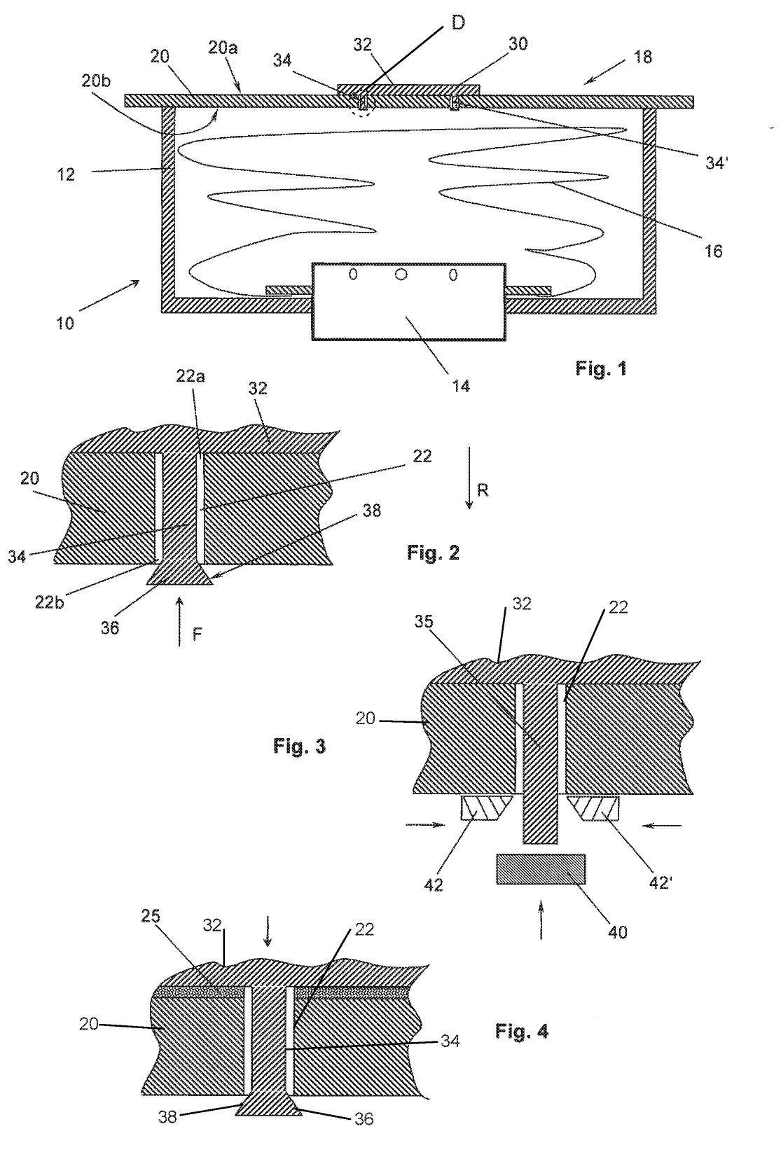

FIG. 1 shows a highly schematized cross-section through an airbag module, and FIG. 2 shows the detail D in FIG. 1, also in a highly schematized representation. The construction of the inventive airbag cover will now, to begin with, be explained with reference to these two Figures.

The airbag model 10 schematically represented in FIG. 1, which illustrates a representative driver-side air-bag module, but which can also concern a passenger-side airbag, having a housing 12, an airbag 16 folded into this housing, an airbag gas generator 14, and an airbag cover 18 that spans the accommodation space into which the airbag 16 is folded. The airbag cover 18 can, as shown in FIG. 1, be permanently attached to the housing 12, however this is not mandatory. In the case of a passenger-side airbag, the airbag cover 18 can also be part of an instrument panel, and it can (in the case of a driver-side airbag) also be depressible against the housing 12 (floating cover concept). In each case, when the gas generator 14 is actuated and the airbag 16 expands, the cover element 20 opens an opening through which the airbag 16 can escape. To this end, the airbag cover 18 generally has at least one hinge line and at least one break line, which is however not shown in FIG. 1, so that a door is formed. An emblem or design section 32 is arranged on this door.

The airbag cover 18 includes a cover element 20 and an emblem or design element 30 held on the cover element 20. The cover element consists of a plastic, and can in particular be formed in one-piece. In particular, it is as a rule not necessary to provide reinforcement elements, so the cover element 20 must have a relatively high inherent rigidity and preferably having a Shore-D hardness of at least 37 (ISO 868). A suitable material is, for example, TOSI 81835D, a TPE. According to the definitions made here, the upper side 20a of the cover element 20 faces the vehicle interior, whereas the lower side 20b of the cover element 20 points at least in sections toward the direction of the airbag 16. The cover element 20 has at least two openings (in FIG. 2, the opening 22 is shown), which extend in the axial direction from the upper side 20a to the lower side 20b of the cover element 20 and thus have an upper end 22a (in FIG. 2) and a lower end 22b (in FIG. 2).

The openings 22a and 22b serve the purpose of the arrangement of an emblem or design element 30 on the cover element 20. The emblem or design element 30 has the emblem or design section 32 (which can for example show the logo of a vehicle manufacturer) and a fastening pin 34, 34′ for each opening 22. The emblem or design element is as a rule formed in one piece from a thermoplastic, the emblem or design section 32 usually being coated, in particular chrome-plated.

As a rule, both fastening pins 34 are identically constructed, however only one of the fastening pin 34 will be referred to and described. The end of the emblem or design section 32 facing away from the fastening pin 34 is formed as a thickened head 36 whose diameter is larger than the cross-section of the opening 22. An improvement consists of the contact surface 38 of the head 36, i.e. the opening pointing in the direction of the lower side 20b of the cover element 20, which holds the emblem or design element 30 on the cover element 20, not being formed as flat and extending vertically in the axial direction R of the fastening pin 34, but rather, at least in sections, running diagonally to this axial direction. In other words: the surface normal to the contact surface 38 extend at least partially non-parallel to the axial direction R of the fastening pin 34. In the embodiment shown, the contact surface 38 is conical (i.e. it is a cone-mantle section), so that the aforementioned requirement for the contact surface 38 applies.

The advantage of the head geometry shown is as follows: during the unfolding of the airbag 10, high acceleration forces act on parts of the airbag cover 18, in particular also on the part of the airbag cover with the emblem or design element 30 (the door). Here, acceleration forces can also arise that tend to tear the emblem or design element 30 off the cover element 20, that is to say which act in the direction F (parallel to the axial direction R). Due to the chosen form of the contact surface 38, the contact surface (even if the cover element 20 consists of a relatively hard plastic), can, during plastic and/or elastic deformation of the cover element 20, dig into and deform the cover element (a certain crumple zone is thus made available), by which means the force-peaks that occur can be reduced.

In order to give the head 36 its desired conical form, a three-part tool, as shown symbolically in FIG. 3, can be used, which has an axial punch 40 and two radial dies or punches 42, 42′, wherein the two radial punches 42, 42′ give the contact surface 38 its form. This manufacturing process takes place as follows. Initially the fastening pin is a straight pin 35 (i.e. without a head). In this state, the emblem or design element 30 is arranged on the cover element 20 such that the straight pins 35 extend through their assigned openings 22. After that, the two radial punches 42, 42′ are moved toward each other (in the direction of the arrow in FIG. 3), and then the radial punch 42 presses on the end of the straight pin 35. During this process, at least the axial punch 40 may be heated, so that a thermal reshaping of the straight pin takes place and the head 36 is formed. After this assembly process is finished, the radial punches 42, 42′ at least must be moved apart again.

In order get a better attachment of the contact surface 38 of the head 36 to the underside 20b of the cover element 20 in the normal operating state of the airbag module 10 so that the emblem or design element 30 is held free from play, it can be advantageous to press the emblem or design section 32 onto the upper surface 20a of the airbag cover 18 during the reshaping of the hollow pins 35 in order to achieve a certain elastic deformation of the cover element 20. If the base material of the cover element 20 has only very low elasticity, it can be advantageous to provide an elastic intermediate layer 25, on which the emblem or design section 32 lies as shown in FIG. 4. According to the definitions made here, the elastic intermediate layer 25 is a part of the cover element 20.

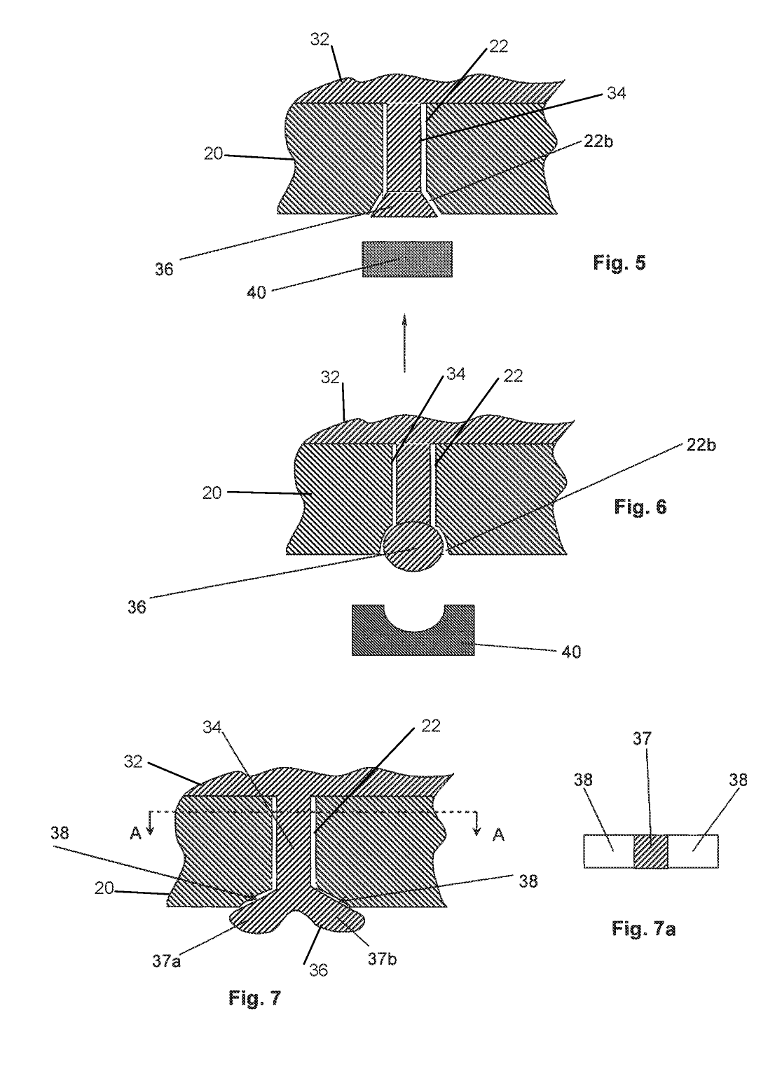

FIG. 5 shows a second exemplary embodiment of the invention in a representation corresponding to FIG. 2. The basic construction of the airbag module, and in particular the airbag cover, is as it is in the first exemplary embodiment, so this will not be explained again, in order to avoid repetition. The form of the head 36 is the same as in the first exemplary embodiment, i.e. the contact surface is conical. The difference compared to the first exemplary embodiment is that the lower end 22b of the opening 22 is also conically shaped, so that the lower end 22b of the opening 22, at least in sections, follows the form of the contact surface 38. This can sometimes be an advantage, particularly as regards the following two aspects: firstly the head 36 is then at least in sections sunk into the opening 22 assigned to it, which reduces the risk of the head 36 contacting the airbag 16. Secondly the form of the lower end 22b of the opening 22 (or more precisely the form of the surface of the lower end 22b of the opening 22) can be used to shape the head 36, so that only a one-piece shaping tool consisting of one heatable axial punch 40 is required.

FIG. 6 shows a variation of the example shown in FIG. 5 where the head 36 is essentially formed as spherical or egg-shaped.

FIG. 7 shows a further form of the head 36, which here has two limbs 37a, 37b, so that the contact surface 38 has two sections separated from each other. This form facilitates the penetration of the head into the cover element, so that inventive success is achieved in a particularly positive way. In addition, this form of the head can be easily produced by means of thermal forming. FIG. 7a shows a section through the fastening pin 34 along the plane A-A, wherein the cover element is not shown. It is seen that the section of the fastening pin that extends through the opening 22 has a quadratic (in general rectangular) cross-section, i.e. that the straight pin also had a cross-section of this kind.

While the above description constitutes the preferred embodiment of the present invention, it will be appreciated that the invention is susceptible to modification, variation and change without departing from the proper scope and fair meaning of the accompanying claims.

1. An airbag cover comprising a cover element having an upper side and a lower side, the cover element having at least two openings that extend from an upper end to a lower end in an axial direction, and
an emblem or design element disposed on the cover element having a visible emblem or design section arranged on the upper side of the cover element and at least two fastening pins that extend respectively in axial direction from the emblem or design section through the cover opening, wherein the fastening pins have a thickened head, and a contact surface of the head facing toward the lower side of the cover element does not extend vertically, at least in sections, to the axial direction.

2. An airbag cover according to claim 1, further comprising the contact surface is formed as non-flat, in a conical or a convex form.

3. An airbag cover according to claim 1, further comprising the lower end of the opening adjacent to the lower side of the cover element through which opening the fastening pin protrudes follows the form of the contact surface, so that the head, at least in sections, is accommodated in the lower end of the opening.

4. An airbag cover according to claim 1 further comprising in that the cover element, at least in the region under the emblem or design section, is formed in one piece, and that at least in this region, no further elements are arranged in or on the cover element.

5. An airbag cover according to claim 1 further comprising in that the thickened head has two limbs, so that the contact surfaces have two sections separated from each other.

6. An airbag cover according to claim 1 further comprising in that the section of the fastening pin extending through the opening has a rectangular cross-section.

7. A method of manufacturing an airbag cover comprising providing a cover element having an upper side and a lower side, the cover element having at least two openings that extend from one upper end to one lower end in an axial direction, and
an emblem or design element disposed on a cover element which has a visible emblem or design section arranged on the upper side of the cover element and at least two fastening pins that extend respectively in axial direction from the emblem or design section through the opening, and forming a thickened head by thermal shaping of the pin extending through the opening, wherein the contact surface of the head facing toward the lower side of the cover element does not extend vertically, at least in sections, to the axial direction.

8. A method of manufacturing an airbag cover in accordance with claim 7 further comprising providing an elastic intermediate layer positioned between the emblem or design element and the cover element, and compressing the emblem during the forming of the thickened head step.

9. An airbag cover according to claim 2 further comprising the lower end of the opening adjacent to the lower side of the cover element through which fastening pin protrudes follows the form of the contract surface and is concave or convex.

10. An airbag cover according to claim 1 further comprising an elastic intermediate layer positioned between the emblem or design element and the upper side of the cover element.
